(19) United States
(12) Patent Application Publication
(10) Pub. No.: US 2002/0140561 A1
(43) Pub. Date: Oct. 3, 2002

(54) Patient alerting system

(76) Inventor: William Baxter, Saline, MI (US)

Correspondence Address: John G. Posa, Gifford, Krass, Groh, Sprinkle, Anderson & Citkowski, P.C., 280 N. Old Woodward Ave., Suite 400, Birmingham, MI, 48009-5394, US

(21) Appl. No.: 10/102,281

(22) Filed: Mar. 20, 2002

Related U.S. Application Data
(62) Division of application No. 60/280,019, filed on Mar. 30, 2001.

(51) Int. Cl. G08B 13/14

(52) U.S. Cl. 340/573.1; 340/665

(57) ABSTRACT

A hand-held device allows a patient to communicate discomfort to a medical or dental practitioner in an immediate and visible manner. With the push of a button, a highly visible light will be illuminated to alert the dentist of patient difficulty. A clip is provided for attachment of the light to the dental bib, create an immediate signal for the dentist and/or dental assistant. The device represents a significant improvement over patient “hand raising” or other forms of audible or vocal alert that could easily be obscured by the sound of the dental handpiece. The invention may prove to be especially helpful for treatment of the pediatric dental population. General dentists, endodontists, oral and maxillofacial surgeons, pedodontists, periodontists, and prosthodontists will all benefit from the use of the device.

### REFERENCE TO RELATED APPLICATION

This application claims priority from U.S. provisional patent application Serial No. 60/280,019, filed Mar. 30, 2001, the entire contents of which being incorporated herein by reference.

### FIELD OF THE INVENTION

This invention relates generally to medical/dental patient communication apparatus and, in particular, to an inexpensive device enabling a patient to communicate discomfort to a practitioner in an immediate and visible manner.

### BACKGROUND OF THE INVENTION

Despite the many advances that have been made in the practice of dentistry, dental appointments remain anxiety-producing, stressful experiences for many patients. Numerous studies have concluded that nearly fifty percent of adults in this country do not seek dental care because of fear. An estimated nine to fifteen percent neglect significant needs secondary to their anxiety surrounding the dental experience. Patients often feel as if they are not in control and worry that their dentist will not know if they are experiencing pain or discomfort.

While there have been attempts to address this problem, the solutions tend to be overcomplicated. For example, U.S. Pat. No. 4,810,996 describes a dental patient communication device to be used in instances when verbal communication is impossible or impracticable such as during dental examination and treatment. The device includes a hollow housing, at least one and preferably three alarm buttons, and at least one audible alarm circuit capable of emitting a variety of distinct sounds. The sounds are activated by the alarm buttons so that the communication of the sensation of various levels of discomfort is accomplished between the patient and the dentist. The device is designed to be either held freely in the patient's hand or gripped while mounted on an examination apparatus, such as a dental chair.

U.S. Pat. No. 5,349,340 teaches mobile apparatus for attachment to a hospital bed, gurney, wheelchair, or similar transport device, including an attendant call button operable by the patient in case of an emergency, thereby activating a signal to summon an attendant. In a preferred embodiment, the signal includes both a visual indicator and an audible indicator, wherein the visual indicator is a light positioned at the distal end of a stanchion mounted to a housing, and the audible indicator is a beeper disposed within the housing. The call button is attached to the distal end of a retractable power cord and has a clip associated therewith for securing the button to the patient's clothing, bed covering, or other location convenient for the patient. Electronic circuitry contained within the housing and powered by a rechargeable battery is employed to sequentially control the operation of the light and beeper. The housing is easily detachable from the transport apparatus to facilitate recharging of the battery.

In this age of health care, consumers evaluate and choose care-givers who demonstrate compassion and involve the patient in the process of treatment. Dentists who are able to communicate concern and empathy for their patients are able to enhance treatment plan acceptance and patient loyalty.

The need remains, therefore, for an inexpensive device enabling a patient to communicate discomfort to a practitioner in an immediate and visible manner. This will allow patients to benefit from the confidence of knowing that they have increased control over their appointment. The practitioner will derive comfort in the ability to immediately ascertain any difficulties that their patient may have during treatment.

### SUMMARY OF THE INVENTION

Broadly this invention allows a patient to communicate discomfort to a medical or dental practitioner in an immediate and visible manner. In the preferred embodiment, the invention takes the form of a hand-held communication device for patient use in the dental chair. With the push of a button, a highly visible light will be illuminated to alert the dentist of patient difficulty. A clip is provided for attachment of the light to the dental bib, create an immediate signal for the dentist and/or dental assistant.

The device represents a significant improvement over patient “hand raising” or other forms of audible or vocal alert that could easily be obscured by the sound of the dental handpiece. The invention may prove to be especially helpful for treatment of the pediatric dental population. General dentists, endodontists, oral and maxillofacial surgeons, pedodontists, periodontists, and prosthodontists will all benefit from the use of the device.

### BRIEF DESCRIPTION OF THE DRAWINGS

FIG. 1 provides a detailed description of the preferred embodiment; and

FIG. 2 shows the invention in use.

### DETAILED DESCRIPTION OF THE INVENTION

As discussed above, this invention provides an inexpensive device enabling a patient to communicate discomfort to a practitioner in an immediate and visible manner. Although the invention may be used in non-dental situations such as medical procedures involving little or no anesthesia, the system is particularly well suited to the practice of dentistry.

The unit is designed for all dentists and dental specialties that provide invasive care. The invention may prove to be especially helpful for treatment of the pediatric dental population. General dentists, endodontists, oral and maxillofacial surgeons, pedodontists, periodontists, and prosthodontists will all benefit from the concept of this idea. Their patients will gain confidence through communication.

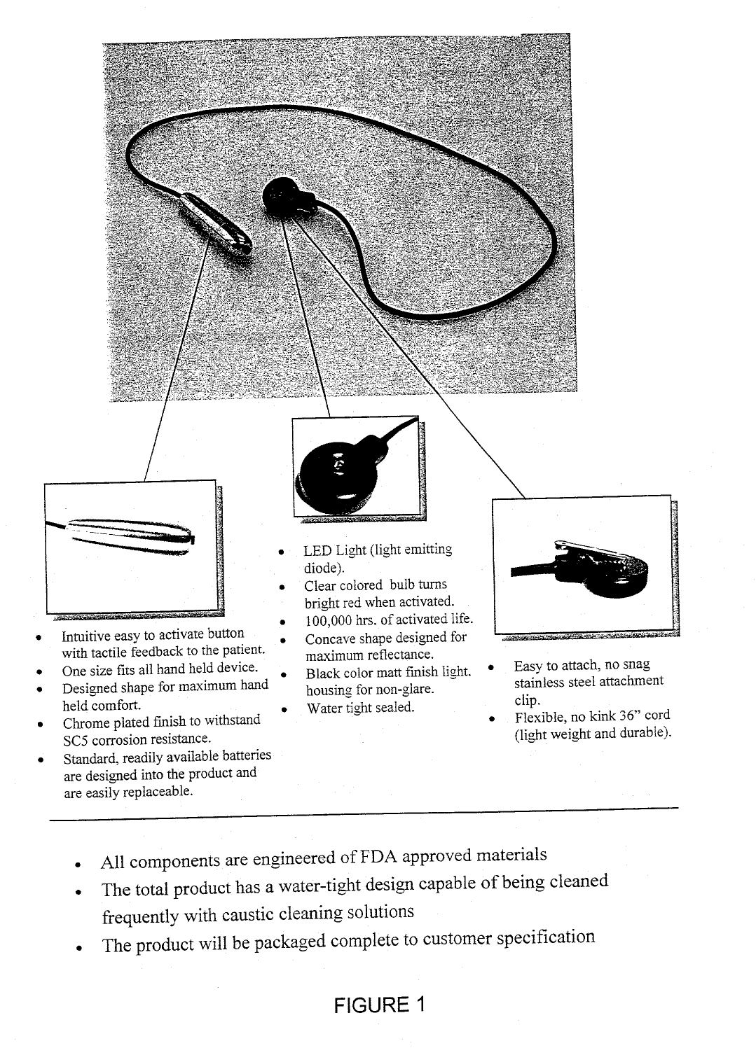

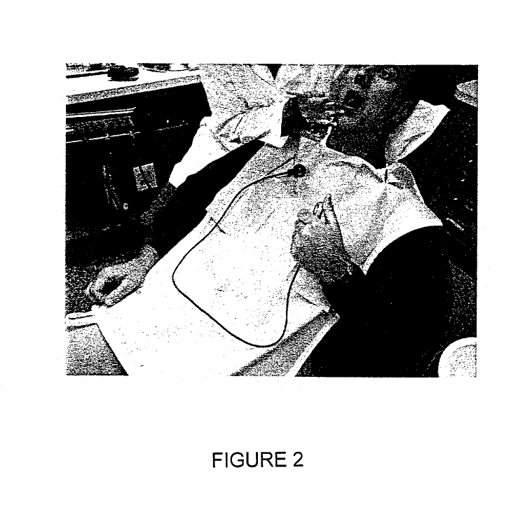

In the preferred embodiment, the product is designed as a hand-held communication device for patient use in the dental chair. FIG. 1 provides a detailed description of the preferred embodiment. The light, switch, and power source are preferably wired in series, though the batteries may be placed in parallel depending upon voltage and/or current requirements. FIG. 2 shows the invention in use.

With the push of a button, a highly visible light will be illuminated to alert the dentist of patient difficulty. A clip is provided for attachment of the light to the dental bib, create an immediate signal for the dentist and/or dental assistant. The device represents a significant improvement over patient “hand raising” or other forms of audible or vocal alert that could easily be obscured by the sound of the dental handpiece.

I claim:

1. A device for alerting a dentist or other practitioner that a patient is experience discomfort, comprising:
a source of electrical power;
a hand-held device for use by the patient, the device including a momentary contact pushbutton; and
a light in operative electrical communication with the source of electrical power and momentary contact pushbutton, enabling the patient to signal the practitioner by pressing the button.

2. The device of claim 1, wherein the source of electrical power includes a battery housed in the hand-held unit.

3. The device of claim 1, further including a clip enabling the light to be worn by the patient.
